(19) United States
(12) Patent Application Publication
(10) Pub. No.: US 2013/0018690 A1
(43) Pub. Date: Jan. 17, 2013

(54) SOFTWARE AND METHOD FOR REQUESTING AND SCHEDULING SUBSTITUTE GOLFERS IN A GOLF LEAGUE

(71) Applicant: Richard Bertrand Weinberg, JR., Highland, MI (US)

(72) Inventor: Richard Bertrand Weinberg, JR., Highland, MI (US)

(21) Appl. No.: 13/547,028

(22) Filed: Jul. 11, 2012

Related U.S. Application Data
(60) Provisional application No. 61/506,522, filed on Jul. 11, 2011.

(51) Int. Cl. G06Q 10/10

(52) U.S. Cl. 705/7.19

(57) ABSTRACT

Software and methods allow a league golfer to schedule a substitute golfer or request a need for a substitute. If a substitute golfer is scheduled, the golfer is notified. If a substitute golfer is not scheduled, all potential substitute golfers that are loaded into the system will be notified of the request. The first substitute golfer to respond to the request is automatically scheduled in place of the league golfer. The system automatically notifies the league golfer that the request has been fulfilled. Previously, golfers and league secretaries relied on making phone calls, leaving messages and manually sending emails to find a substitute golfer. The system notifies all available golfers simultaneously and requires less effort. The system accepts only one substitute golfer for each request, based on whichever substitute responds first. All others are notified that the request is no longer available and prevented from accepting the request.

### CROSS-REFERENCE TO RELATED APPLICATION

This application claims the benefit of priority of U.S. provisional application No. 61/506,522, filed Jul. 11, 2011, the contents of which are herein incorporated by reference.

### BACKGROUND OF THE INVENTION

The present invention relates to golf scheduling tools and, more particularly, to software and methods for requesting, scheduling and cancelling substitute golfers in a golf league using a computer or electronic device.

Golfers on golf leagues currently spend a significant amount of time and effort calling and sending emails to find a substitute golfer to play in their place if they cannot play on their league's golf day.

Previously, golfers and league secretaries relied on making phone calls, leaving messages and manually sending emails to find a substitute golfer. This can prove to be inefficient, as if too few requests are sent, it could result in no replies, or, if too many requests are sent, it could result in multiple acceptances to an invitation to play. In either event, the act of trying to find a substitute golfer to take one's place on their league's golf day can be tedious, time-consuming and can result in uncertainty and confusion for both the league golfer and his or her substitute.

As can be seen, there is a need for an improved system for requesting, scheduling and cancelling substitute golfers in a golf league.

### SUMMARY OF THE INVENTION

In one aspect of the present invention, a computer-implemented method, written as a programmable code, stored on a computer readable medium, and adapted to manage golf league scheduling, where the method comprises creating a request for a substitute golfer by signing into a computer-based scheduling system and posting the need for the substitute golfer; permitting the substitute golfer to accept the request; notifying a league golfer and the substitute golfer of a schedule change; allowing the league golfer to remove the request; and allowing the substitute golfer to remove themselves as a substitute golfer.

In another aspect of the present invention, a computer-based scheduling system computer software, written as a programmable code, stored on a computer readable medium, and adapted to manage golf league scheduling, where the software comprises a computer code segment for creating a request for a substitute golfer by signing into the computer-based scheduling system and posting the need for the substitute golfer; a computer code segment permitting the substitute golfer to accept the request; a computer code segment notifying a league golfer and the substitute golfer of a schedule change; a computer code segment allowing the league golfer to remove the request; and a computer code segment allowing the substitute golfer to remove themselves as a substitute golfer.

These and other features, aspects and advantages of the present invention will become better understood with reference to the following drawings, description and claims.

### BRIEF DESCRIPTION OF THE DRAWINGS

FIG. 1 is a flow chart describing a method for scheduling a substitute golfer or creating a request for a substitute golfer according to an exemplary embodiment of the present invention;

FIG. 2 is a flow chart describing a method for a substitute golfer to accept a request according to an exemplary embodiment of the present invention;

FIG. 3 is a flow chart describing a method for a league golfer to unscheduled a previously scheduled substitute golfer or cancel a request for a substitute golfer according to an exemplary embodiment of the present invention; and

FIG. 4 is a flow chart describing steps taken when a scheduled substitute cancels, according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides software and methods that allows a league golfer to schedule a substitute golfer or request a need for a substitute. All potential substitute golfers that are loaded into the system will be notified of the request. The first substitute golfer to respond to the request is automatically scheduled in place of the league golfer. The system automatically notifies the league golfer that the request has been fulfilled. Previously, golfers and league secretaries relied on making phone calls, leaving messages and manually sending emails to find a substitute golfer. The software and methods of the present invention notifies all available golfers simultaneously and requires less time and effort. The software and methods of the present invention will accept only one substitute golfer for each request, based on whichever substitute is the first to respond. All others are notified that the request is no longer available and prevented from accepting the request.

The software of the present invention may be written in any one or more programming languages. In some embodiments, the software may be designed to operate on a computer system, having a central processing unit, memory and other typical computer components. In some embodiments, the software may reside on a server and operate on various computers or computer terminals. In some embodiments, the software may reside at least partially on a server or cloud-based system or on an internet-based system or on a portable electronic device, such as a smartphone, where data from a database may be interchanged with the software of the present invention. Security measures may be included with the software, such as data encryption, to permit the secure exchange of information.

The software of the present invention may include computer code, disposed on a computer readable medium, adapted to perform the various functions as described herewithin. The software of the present invention may be capable of retrieving data from the tax preparation software and transforming that data into one or more valuable reports.

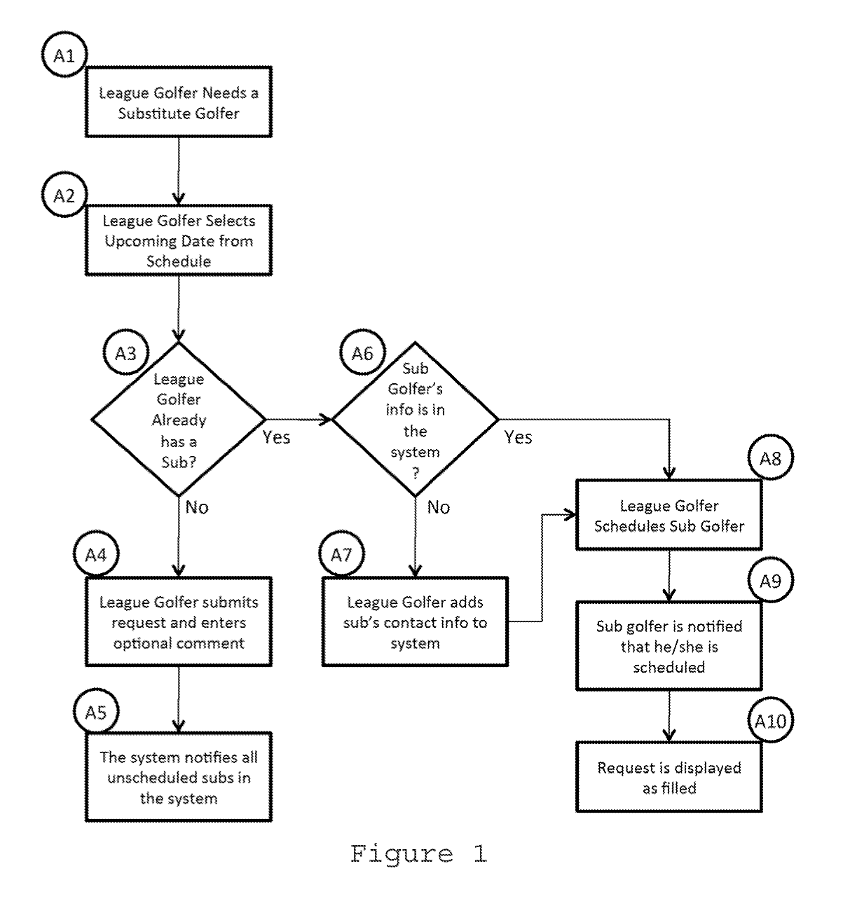

Referring now to FIGS. 1 through 4, the included steps list the two key participants as the league golfer that is looking for a substitute golfer, and the substitute golfer that is looking for a request. In another embodiment, the key participants could be substituted with alternative parties, which could include but are not limited to a league member's teammate or the league secretary or manager. These parties could act as either the league member seeking a substitute or as the substitute seeking an open request.

The software of the present invention can run on an automated website or mobile application that maintains a golf league's schedule and contains a list of league golfers and substitute golfers, including their contact information, such as email addresses, and can perform the notifications and scheduling of substitute golfers. The software can, for example, reside on a website server or on a mobile device. The associated data, such as the schedules and list of golfers and substitute golfers may be available on from a separate database that may be stored locally (on the website server or mobile device) or may be accessed remotely, such as when the database resides on a cloud-based system.

A member of a league that has an account in the system can log into the league account and select the date that a substitute will be needed. If the league golfer already knows who will be substituting for them, the league golfer can schedule the substitute golfer in their place. The system replaces the league golfer with the substitute golfer on the schedule.

If the league golfer does not already have agreement from a substitute golfer, the league golfer can click a button and all unscheduled substitute golfers that are already listed in the system will be sent a notification informing them of the request.

The substitute golfers can access the system and view all open requests in the league account. They can schedule themselves for any open requests and the system will replace the league golfer with the substitute golfer on the schedule, and notify the league golfer that the request has been accepted.

League golfers and substitute golfers can also log into the league account to cancel requests that they have submitted or accepted. All involved parties will be notified of the cancellation.

More specifically, with reference to FIG. 1, the methodology can work as follows. When a league golfer needs a substitute to play in his/her place (Step A1) for an upcoming scheduled league game, the league golfer accesses the system, for example by logging into a website, and selects the scheduled date (Step A2).

If (Step A3) a substitute golfer has already agreed to play on the scheduled date through any communication method such as verbal, email, or the like, the league golfer selects the substitute golfer's name from a list (Step A8). If (Step A6) the substitute golfer's information is not already in the system, the league golfer can enter the information (Step A7). The system then updates the schedule and notifies the substitute golfer (Step A9) and the request is displayed as fulfilled (Step A10).

If the league golfer does not already have agreement from a substitute golfer, the league golfer can click a button and enter additional information as needed (Step A4) and all unscheduled substitute golfers that are already listed in the system will be sent a notification informing them of the request (Step A5).

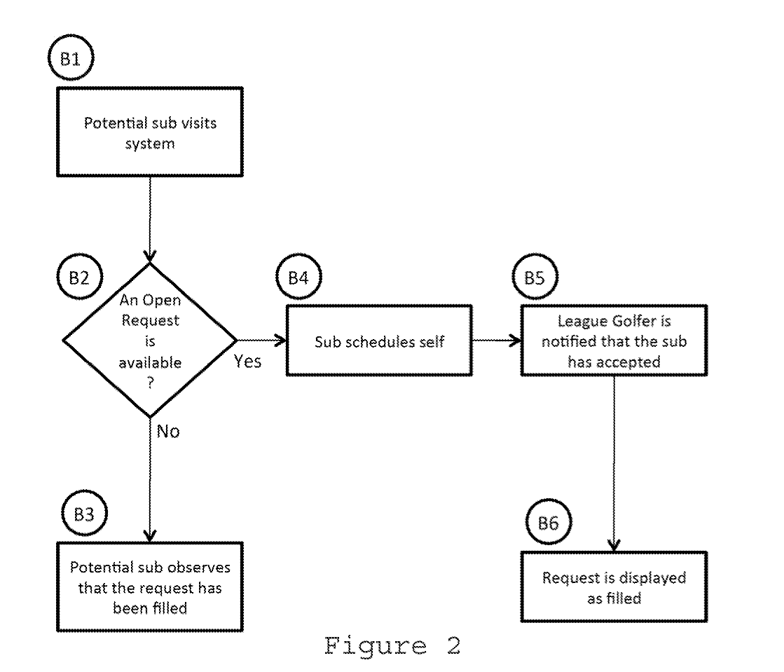

Referring now to FIG. 2, a potential substitute golfer can access the system (Step B1), such as a website, and view all open requests for substitute golfers (Step B2). The potential substitute golfer may have arrived at the site in response to a specific request from a league golfer, or just to access other information about the league such as the schedule. The substitute golfer can accept any open requests that are currently listed in the system by simply clicking on the request and confirming the intent to play (Step B4). The system updates the schedule and the league golfer that submitted the request is notified (Step B5) and the request is marked as fulfilled (Step B6). If the substitute golfer finds no open requests, they can observe requests that have been fulfilled (Step B3) in the system.

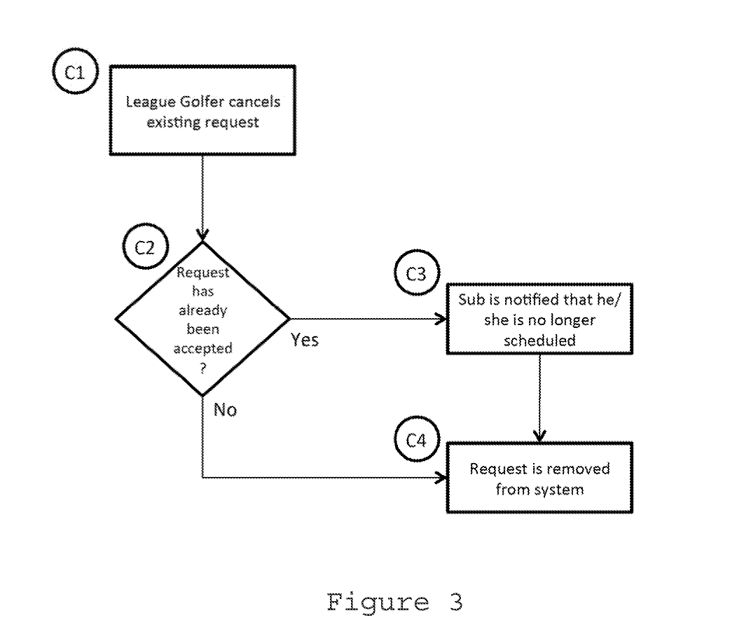

Referring to FIG. 3, a league golfer can cancel a request that he/she previously submitted (Step C1) by accessing the system, for example a website, selecting the request and clicking cancel. If (Step C2) a substitute golfer has already accepted the request, the substitute golfer will be notified that the request is no longer available (Step C3) and the request will be removed from the system (Step C4). If the request was not yet accepted by a golfer, the request is simply removed from the system (Step C4).

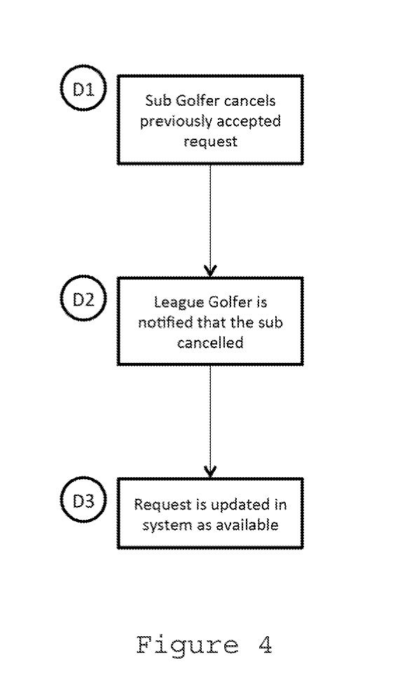

Referring to FIG. 4, a substitute golfer that previously accepted a request can cancel their acceptance (Step D1) by accessing the system, selecting the request and clicking the cancel button. The substitute golfer can optionally enter a message that will be sent to the league golfer. The league golfer that made the request is notified that the golfer cancelled (Step D2) and the request is updated as available (Step D3). If another potential substitute golfer accesses the system, the open request will be displayed and can be accepted.

While the above description refers to golf league scheduling, the software and methods of the present invention could be applied to other league scheduling situations. For example, possible sports fields that could use the software and methods of the present invention could include bowling, baseball and basketball leagues where a schedule is maintained.

It should be understood, of course, that the foregoing relates to exemplary embodiments of the invention and that modifications may be made without departing from the spirit and scope of the invention as set forth in the following claims.

What is claimed is:

1. A computer-implemented method, written as a programmable code, stored on a computer readable medium, and adapted to manage golf league scheduling, the method comprising:
creating a request for a substitute golfer by signing into a computer-based scheduling system and posting the need for the substitute golfer;
permitting the substitute golfer to accept the request;
notifying a league golfer and the substitute golfer of a schedule change;
allowing the league golfer to remove the request; and
allowing the substitute golfer to remove themselves as a substitute golfer.

2. The computer-implemented method of claim 1, further comprising immediately scheduling the substitute golfer for the league golfer, where the substitute golfer agreed to fulfill the request ahead of time.

3. The computer-implemented method of claim 1, further comprising showing a fulfilled request on the scheduling system when the substitute golfer accepts the request.

4. The computer-implemented method of claim 1, further comprising posting the request as an open request when the substitute golfer cancels their acceptance of the request.

5. The computer-implemented method of claim 1, wherein the request is made by the league golfer or a proxy for the league golfer.

6. A computer-based scheduling system computer software, written as a programmable code, stored on a computer readable medium, and adapted to manage golf league scheduling, the software comprising:
a computer code segment for creating a request for a substitute golfer by signing into the computer-based scheduling system and posting the need for the substitute golfer;
a computer code segment permitting the substitute golfer to accept the request;
a computer code segment notifying a league golfer and the substitute golfer of a schedule change;
a computer code segment allowing the league golfer to remove the request; and
a computer code segment allowing the substitute golfer to remove themselves as a substitute golfer.

7. The software of claim 6, wherein the scheduling system is accessible via an internet connection.

8. The software of claim 6, wherein the scheduling system is accessible on a portable electronic device.

9. The software of claim 8, wherein the portable electronic device is a smartphone.

10. The software of claim 6, further comprising computer code for allowing the immediate scheduling the substitute golfer for the league golfer when the request is created, where the substitute golfer agreed to fulfill the request ahead of time.

11. The software of claim 6, further comprising computer code for showing a fulfilled request on the scheduling system when the substitute golfer accepts the request.

12. The software of claim 6, wherein the request is made by the league golfer or a proxy for the league golfer.
